(19) United States
(12) Patent Application Publication
(10) Pub. No.: US 2020/0393945 A1
(43) Pub. Date: Dec. 17, 2020

(54) INPUT METHOD AND INPUT APPARATUS USING DETECTION OF POSSESSION OF FINGER

(71) Applicant: Jonghwan PARK, Paju-si (KR)

(72) Inventor: Jonghwan PARK, Paju-si (KR)

(21) Appl. No.: 16/971,661

(22) PCT Filed: Dec. 18, 2018
(86) PCT No.: PCT/KR2018/016069

§ 371 Date: Aug. 20, 2020

(30) Foreign Application Priority Data
Feb. 21, 2018 (KR) 10-2018-0020449

(51) Int. Cl. G06F 3/0487

(52) U.S. Cl. CPC G06F 3/0487; G06F 2203/04101

(57) ABSTRACT

Disclosed technology relates to an input method and an input apparatus using detection of possession of a finger, the input method comprising the steps of: detecting a user's finger possessing a particular area of a partial area, in which a sensor is disposed in an interface area, by an input apparatus; detecting, by the input apparatus, an input of a particular key among multiple keys provided in the interface area in a state of detecting the finger; and determining an output value to the input with reference to the position of the particular area, by the input apparatus. Therefore, different output values can be input through one button by processing little calculation amount while considering the position and movement of the user's hand.

### TECHNICAL FIELD

The disclosure relates to a method and an apparatus for determining an output value of a key according to detection of a finger possessing a particular area in an input apparatus.

### BACKGROUND ART

As an input apparatus for a user interface, which is essentially used in various electronic apparatuses, becomes necessary even in a mobile environment, a user interface technology capable of inputting data using a small keypad or a small-sized touch screen is required.

In particular, in the mobile environment, users are required to support a body of an apparatus with one hand, and thus have to complete an input operation just with the other hand. Thus, if a conventional desktop keyboard is simply miniaturized and made into a product, the size of a button becomes extremely small in order to provide the keyboard with the same number of buttons having a small size, so that users feel more tired of carrying out an input operation by moving one hand between a large number of buttons provided on the keyboard. No matter how the device is miniaturized, the size of the button needs to be large enough for users to easily perform an input operation, thereby causing a problem in that an input apparatus may encroach an available screen.

On the other hand, if the device is simply miniaturized, a chance of a typing error becomes high when entering each button or key and usability is also decreased. Thus, the keyboard has been used in such a manner that a small number of buttons having a certain size or larger are set to have a plurality of values, not a single value, and an input is made along with a button for performing a certain function such as Shift button or Function key, after which an inputted value is subjected to transformation. A typical example of the above keyboard is a coded keyboard.

On the other hand, referring to Korean Registered Patent No. 10-0929306 (Title of the invention: Input apparatus and input method), disclosed is a technology for inputting a specific symbol as desired by a user based on a small size, a small number of buttons, the minimum number of inputs (1 symbol 1 click) and the like by using an input apparatus including a key to which a plurality of symbols are assigned and a sensor for detecting a finger, without a need for using a separate conversion key.

However, the above method is performed by detecting a user's all fingers to use the results as a criterion for selecting a symbol. Accordingly, there is a problem in that an amount of computation is increased according to sensing and the number of sensors to be provided is also increased, thereby causing a burden of costs.

### DISCLOSURE

### Technical Problem

An object of the disclosure is to provide a method and an apparatus for determining an output value of a key, in which a plurality of symbols are set according to detection of possession of a finger.

### Technical Solution

In order to achieve the technical object, according to a first aspect of the disclosure, there is provided an input method using detection of possession of a finger, the method comprising: detecting a user's finger possessing a particular area of a partial area, in which a sensor is disposed in an interface area, by an input apparatus; detecting an input of a particular key among a plurality of keys provided in the interface area in a state of detecting the finger, by the input apparatus; and determining an output value for the input based on a position of the particular area, by the input apparatus.

In order to achieve the technical object, according to a second aspect of the disclosure, there is provided an input apparatus using detection of possession of a finger, the apparatus comprising: an input part which includes an interface area, in which a plurality of keys are disposed, and detects an input of a particular key among the plurality of keys; a sensor which is disposed in a partial area of the interface area and detects a state of possession of a user's finger; and a control part which determines an output value of the particular key based on a sensing value transmitted from the sensor and a unique identifier of the particular key.

### Advantageous Effects

The embodiments of the disclosure may have effects including the following advantages. However, since the embodiments of the disclosure are not meant to include all the effects, it should not be understood that the scope of rights of the disclosure is limited thereto.

According to one embodiment of the disclosure, an input method and an input apparatus using detection of possession of a finger have an effect of inputting different output values with one button without interfering with a hand position and movement.

In addition, there is an advantage of providing an input apparatus at a relatively low cost by using a sensor only in a part of the input apparatus.

Furthermore, there is an advantage of efficiently determining an output value by processing a small amount of sensor computation.

### BRIEF DESCRIPTION OF THE DRAWINGS

FIG. 1 is a flow chart showing an input method using detection of possession of a finger according to one embodiment of the disclosure.

FIG. 2 is a block diagram showing an input apparatus using detection of possession of a finger according to one embodiment of the disclosure.

FIG. 3 is a view showing an interface area of an input apparatus according to one embodiment of the disclosure.

FIG. 4 is a view showing a first embodiment of inputting a key according to a detection position of a finger.

FIG. 5 is a view showing a second embodiment of inputting a key according to a detection position of a finger.

FIG. 6 is a view showing a third embodiment of inputting a key according to a detection position of a finger.

FIG. 7 is a view showing a sensor disposed in an input apparatus.

FIG. 8 is a view showing a first embodiment of a sensor which detects a finger.

FIG. 9 is a view showing a second embodiment of a sensor which detects a finger.

FIG. 10 is a view showing a third embodiment of a sensor which detects a finger.

### BEST MODE

The present invention may be applied with various modifications and have various embodiments, but specific embodiments will be illustrated in the drawings and described in detail in the detailed description. However, this is not intended to limit the present invention to specific embodiment forms, and should be understood to include all modifications, equivalents, and substitutes included in the spirit and scope of the present invention.

Terms such as first, second, A, B, etc. may be used to describe various components, but the components are not limited by the above terms, and used only for distinguishing one component from other components. For example, a first component may be referred to as a second component without departing from the scope of the present invention, and similarly, the second component may be referred to as the first component. The term “and/or” includes a combination of a plurality of related described items or any one of a plurality of related described items.

In the present specification, the terms of a singular form should be understood to include plural forms unless clearly interpreted otherwise. And the terms “comprise,” etc., mean that there is a feature, a number, a step, an operation, a component, a part, or a combination thereof described, and should be understood not to exclude the existence or the possibility of addition of one or more other features, numbers, steps, operations, components, parts, or a combination thereof.

Prior to the detailed description of the drawings, it is intended to clarify that the constituent parts in the present specification are simply classified based on the main functions thereof. In other words, two or more constituent parts to be described below may be combined into one constituent part, or one constituent part may be divided into two or more for each subdivided function.

In addition, each of the constituent parts to be described below may further perform a part or all of the functions performed by other constituent parts in addition to the main functions performed by each of the constituent parts, and it is also natural that a part of the main functions performed by each of the constituent parts may be exclusively carried out by other constituents parts. Accordingly, the existence of respective constituent parts described through the present specification should be functionally interpreted.

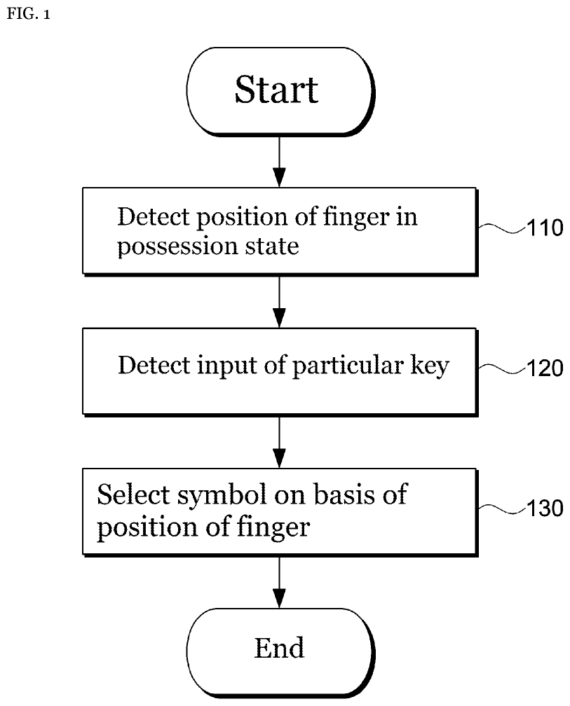

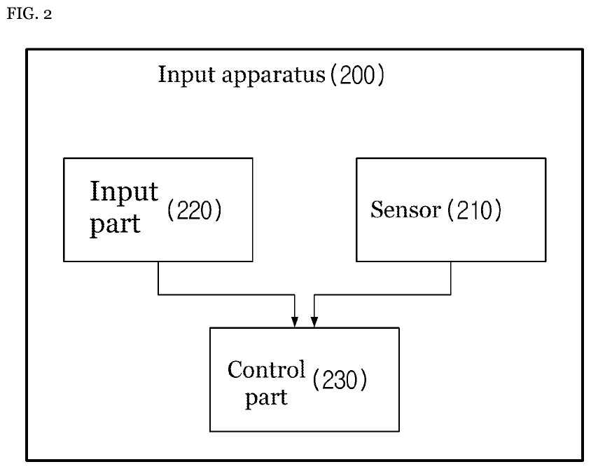

FIG. 1 is a flow chart showing an input method using detection of possession of a finger according to one embodiment of the disclosure. And FIG. 2 is a block diagram showing an input apparatus using detection of possession of a finger according to one embodiment of the disclosure. According to one embodiment of the disclosure, the input method using detection of possession of a finger is performed based on an input apparatus 200, so that hereinafter the detailed description will be provided based on the input apparatus 200.

In step 110, the input apparatus 200 may detect a state of a user's finger possessing a particular area of a partial area, in which a sensor 210 is disposed in an interface area. The input apparatus 200 may decide whether or not the user's finger possesses a particular area of an area in which an input key is disposed. For example, the input apparatus 200 may decide a state of possession of a particular area which is at a left side or at a right side of an area in which an input key is disposed. If the user uses the input apparatus 200 with a right hand, the sensor 210 at the left side may be used to detect that an index finger is in a state of possession, or the sensor 210 at the right side may be used to detect that a little finger is possessing.

In this case, the state of possession refers to a state in which a finger stays on a key in a particular area, rather than inputting the key with the finger. Depending on a method of inputting a key of the input apparatus 200, a finger may possess a key in a particular area without coming into contact with the key, or a finger may possess a key while coming into contact with a surface of the key. In other words, if the input apparatus 200 is to input a key by a touch method, the sensor 210 may detect a state of a finger floating on a particular area, in which a particular key is positioned, so as to decide if the finger is in the state of possession. If the input apparatus 200 uses a method of performing an input by pressing a key, the sensor 210 may detect a finger coming into contact with a key as a state of possession.

Meanwhile, a plurality of keys may have a unique identifier, respectively. In one embodiment, apart from at least one to at most three symbols set to each key, an ID of a corresponding key is set as an identifier, so that the control part 230 included in the input apparatus 200 may obtain information about which key position a finger is in a state of possession, or may confirm which key is inputted.

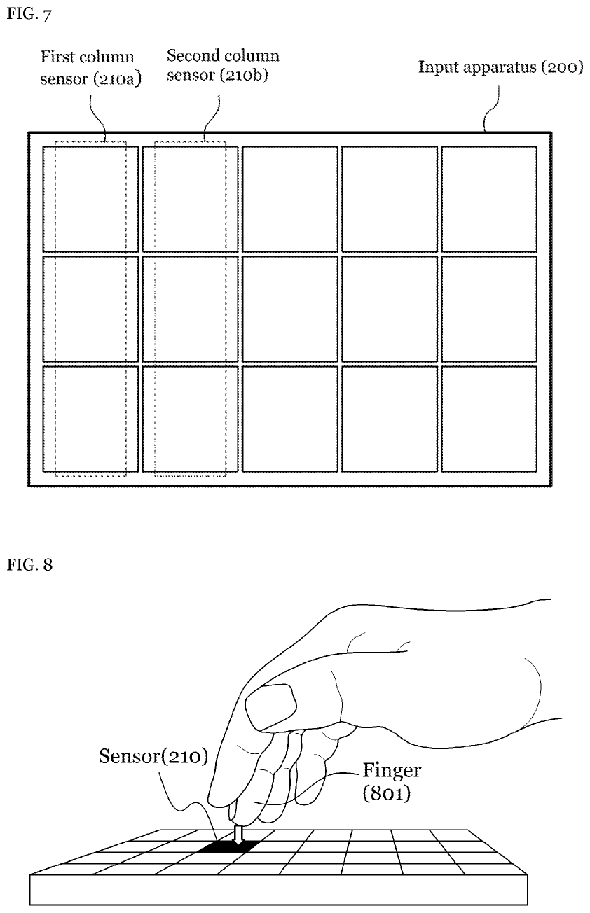

The input apparatus 200 may detect at least one of a plurality of fingers of a user by using a sensor 210 disposed in a partial area. The input apparatus 200 may include a plurality of input columns, and the sensor 210 may be disposed only at a part of the plurality of columns of the input apparatus. In one embodiment, as shown in FIG. 7, the sensors 210a and 210b may be disposed only at a first column and a second column from the left side. More accurately, a sensor device may be inserted into the input apparatus 200 so that a plurality of sensors capable of detecting a finger may be provided in each button of the first column and the second column. The input apparatus 200 may use the sensor 210 disposed as above to detect the cases where the user's finger possesses a part of the first column, possesses a part of the second column, and does not possess both columns. Of course, the keys provided in the input apparatus 200 may be formed in a shape in which the keys are easily inputted one by one with a single finger, so that the user's finger cannot possess all the keys arranged in a particular column at once. Thus, the sensor 210 can detect whether a finger is possessing at a position corresponding to a position of at least one key in a particular column.

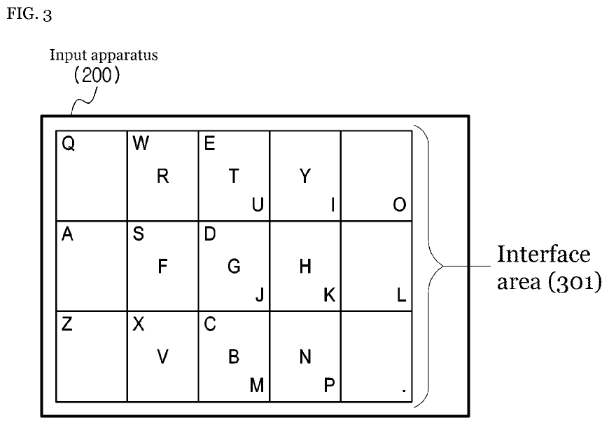

FIG. 3 shows an input apparatus 200 in which keys are disposed at three rows and five columns, respectively. As shown in FIG. 3, the input apparatus 200 may include a predetermined interface area 301, in which a plurality of rows and columns are formed in the interface area 301, and each of the keys is arranged in each row and column. If the user uses the input apparatus 200 by using three fingers of an index finger, a middle finger and a ring finger of the right hand, the sensor 210 needs to be arranged at a minimum of two columns in order to detect the movement of the three fingers. For example, the sensor 210 may be disposed at a first column and a second column from the left side to detect at least one of the three fingers described above. In other words, the number of sensors may be reduced by confirming a state of possession of a finger only at the first column and the second column from the left side.

Meanwhile, referring to FIG. 3 again, it can be confirmed that a plurality of values are set to a part of the keys in the interface area 301. Hereinafter, the value set to each key may be called a symbol. In one embodiment, three symbols of “E”, “T” and “U” may be set to the key disposed at a first row of a third column in FIG. 3 and the user may select one of the three symbols as needed. In this case, a plurality of symbols may not be assigned to all the keys. For example, one symbol may be assigned to a key positioned at the first column, two symbols may be assigned to a key positioned at the second column, and three symbols may be assigned to a key positioned at a third column. In other words, the input apparatus 200 may be formed in such a way that a keyboard split in the form of 3×5 is not folded, but partially overlapped, so that a different number of symbols may be formed at the keys disposed at each column.

In a conventional keyboard, Shift key and a button, to which a plurality of symbols are set, may be inputted together, so that a symbol desired by a user may be changed into an output value. In this case, however, only two symbols may be set to each button. And to input each symbol, it was necessary to carry out a button operation or a key input twice. On the other hand, according to the disclosure, up to three symbols may be set to one key in the input apparatus 200, so that keys can be inputted with a smaller number of typing compared to the related art, thereby reducing a user's fatigue when using the input apparatus 200.

Meanwhile, the type of the sensor 210 disposed in a partial area may be a capacitance-type sensor or an optical sensor. For example, a capacitance value may be detected, or a finger may be detected based on whether the irradiated light is reflected or not, in order to detect the contact of a finger or a position of the finger approaching at a certain distance or more.

In addition, the sensor 210 may detect a position of the finger in a state of contact or non-contact. For example, the finger may be floating in the air while maintaining a predetermined distance above a partial area, or may be in a state of coming into contact with a particular key in the area.

Thus, in case of the sensor 210, various types of sensors may be used to detect all of the above states.

Referring to FIGS. 8 to 10, the sensor 210 may be disposed at the input apparatus 200 in various forms. Referring to FIG. 8 as an example, the sensor 210 may be disposed at a key disposed in the input apparatus 200. Thus, when a finger 801 possesses a key equipped with the sensor 210, or the finger comes into contact with the corresponding key, the sensor 210 may detect the finger. Of course, the position of the key, in which the sensor 210 is disposed, may be a particular area of the interface area, for example, the first column and the second column from the left side.

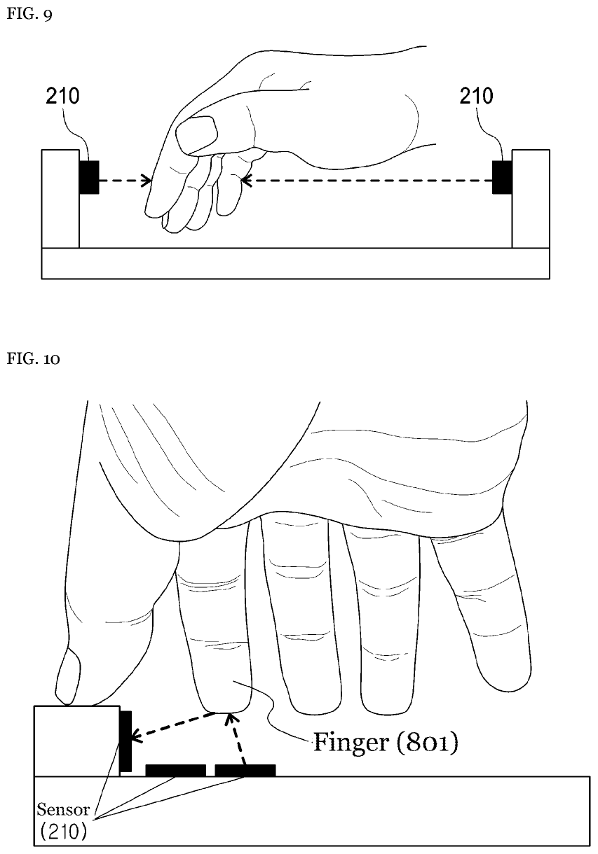

Meanwhile, referring to FIG. 9, the sensor 210 may be disposed on the front and rear surfaces of the input apparatus 200 to detect the finger 801 by a method of irradiating light. In this case, the sensor 210 may be to irradiate light from both sides, in such a way that one side is a light emitting part and the other side is a light receiving part, so if the light irradiated from the light emitting part does not enter the light receiving part, the sensor 210 may detect that the finger blocks the light.

In addition, referring to FIG. 10, the sensor 210 may detect the finger 801 from the side of the sensor. This case is basically similar to the case as shown in FIG. 8, but another sensor may be disposed on a left side to detect the possession of a finger. The finger may be detected in various ways as above.

In step 120, the input apparatus 200 may detect that a particular key is inputted among a plurality of keys provided in the interface area 301 in a state of detecting the finger. In one embodiment, the input apparatus 200 may detect that the user's another finger taps or presses a particular key in a state of detecting one finger possessing the key. In case of inputting a key, an electrical input signal may be conventionally generated accordingly. The input part 220 included in the input apparatus 200 may detect the signal to decide which particular key is inputted. In this case, the input part 200 may recognize a moment of starting a key input as a time point of an event occurrence, and may recognize a moment of completing the input as a time point of the event occurrence. In other words, if the finger presses a key to make an input, the input part may be set to recognize a moment of the finger pressing the key or releasing the key as a time point of event occurrence.

Meanwhile, the input apparatus 200 may perform steps 110 and 120 in parallel. For example, the input apparatus may detect a position of the finger in a state of possession and a key input at the same time to determine a symbol based on both data, or the input apparatus may detect the key input and confirm the position of the finger possessing. Of course, as shown in FIG. 1, the input apparatus may also detect the key input after detecting the position of the finger. In case of not using information on the finger's possession, step 110 may be omitted and step 120 may be performed.

In step 130, the input apparatus 200 may determine one of a plurality of symbols set to a particular key as an output value for the particular key based on a state of the finger in a state of possession. The input apparatus 200 may include a control part 230. The control part 230 may determine an output value by using a sensing value for a position of a finger as well as a symbol value set to a particular key.

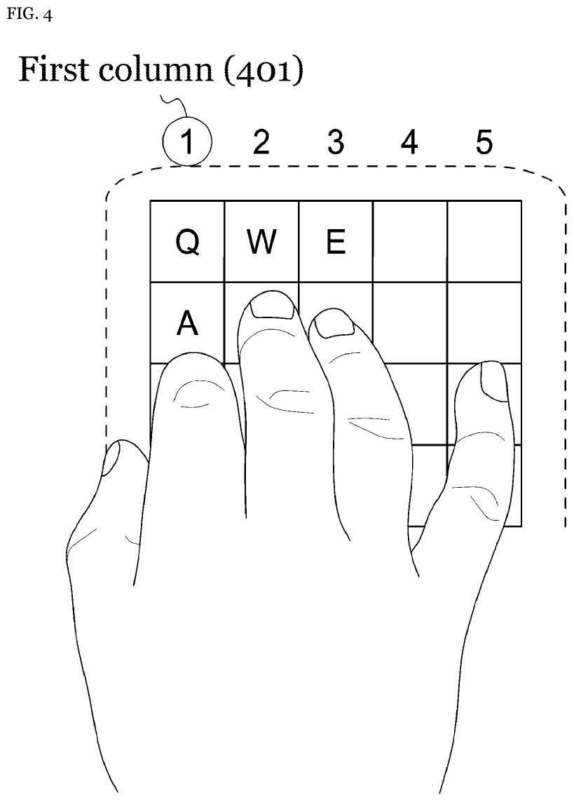

In one embodiment, referring to FIGS. 4 to 6 below, the control part 230 may determine a symbol value of the particular key as the position of the finger is changed. First, description will be made with reference to FIG. 4. If it is decided that the finger is positioned on a first column 401 of the interface area 301, the control part 230 may determine a symbol assigned first to the particular key as an output value. In this case, the input apparatus 200 may actually detect a finger in both columns by using sensors disposed at the first column and the second column. If the finger is detected only from the first column and is not detected from the second column, the control part 230 may decide the finger as an unnatural hand gesture. However, if the number of symbols set to the button of the corresponding column is one, the input apparatus 200 may be set to make an input regardless of the state of possession. In FIG. 4, assuming that the user inputs a key positioned at a third column of a first row in a state of the finger possessing a first column 401, the control part 230 may determine a first symbol “E” set to the corresponding key as an output value. In this case, since an index finger of a right hand possesses the first column 401, a finger for inputting “E” may become a ring finger according to a natural hand shape.

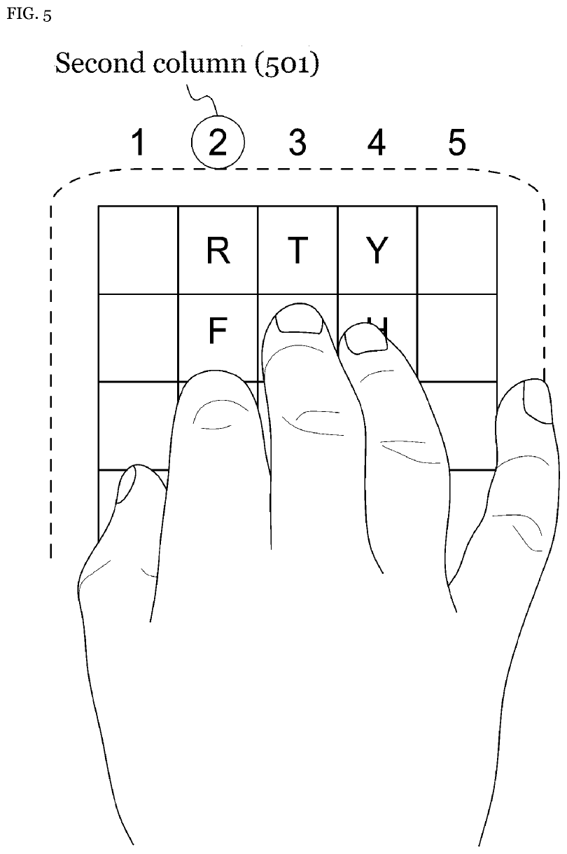

Meanwhile, referring to FIG. 5, if the control part 230 of the input apparatus 200 decides that the finger does not possess the first column, but possesses the second column 501 only, the control part may determine a second symbol assigned to a particular key as an output value. Just as shown in above FIG. 4, if a particular key is positioned at a third column of a first row, a sensing value for the finger may be generated from the second column 501 only, so that “T” among the three symbols of “E”, “T” and “U” set to the corresponding key may be determined as an output value.

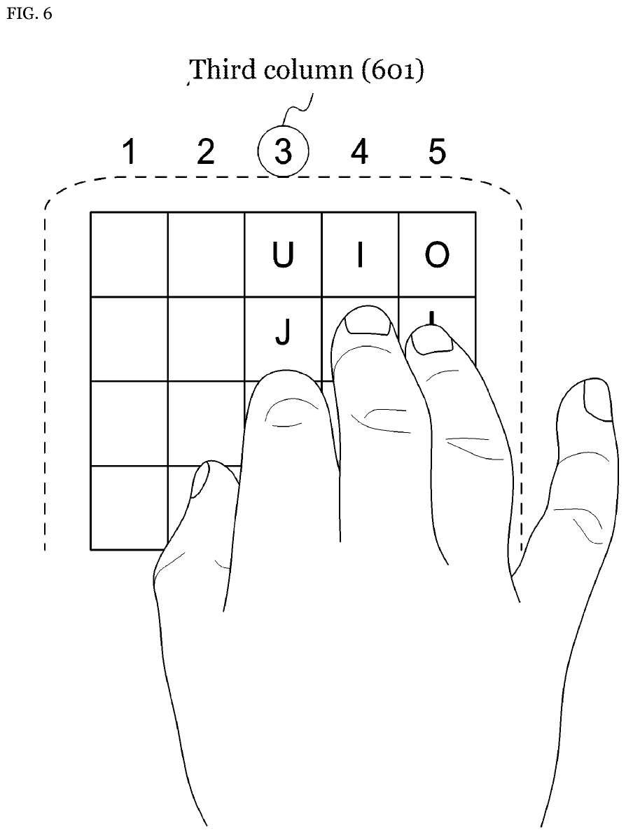

Meanwhile, referring to FIG. 6, if it is decided that the finger is positioned at a third column 601 of a partial area, the control part 230 of the input apparatus 200 may determine a third symbol of the particular key as an output value. In this case, under the condition that the sensor 210 is disposed only at the first column and the second column, the control part may decide a state of not detecting a finger from both columns as a situation for outputting a third symbol. Just as shown in above FIG. 6, if the user inputs a key positioned at a third column of a first row, the control part 230 may determine “U” among the three symbols of “E”, “T” and “U” set to the key as an output value. In this case, just as shown above, if “O” of a fifth column is inputted while a second column 501 is possessed, only one symbol exists in the key to which “O” is assigned, so that input may be performed without conflicting with a control logic. According to the above method, the user can naturally select a desired symbol without making an unnatural shape of the hand or an ineffective movement of the hand, and can conveniently perform an input according to the number of symbols set to each key.

The input method and the input apparatus using the sensing position of the finger according to one embodiment of the disclosure have been described with reference to the embodiments shown in the drawings for better understanding of the disclosure, but they are set forth to illustrate only and those skilled in the art to which the present invention pertains will appreciate that various modifications and other equivalent embodiments are possible. Thus, the true technical protection scope of the disclosure should be determined by the appended claims.

1. An input method using detection of possession of a finger, the method comprising:
detecting a user's finger possessing a particular area of a partial area, in which a sensor is disposed in an interface area, by an input apparatus;
detecting an input of a particular key among a plurality of keys provided in the interface area in a state of detecting the finger, by the input apparatus; and
determining an output value for the input based on a position of the particular area, by the input apparatus.

2. The method of claim 1, wherein the input apparatus comprises a plurality of input columns, and the partial area is a first column and a second column from a left side among the plurality of input columns.

3. The method of claim 2, wherein the input apparatus determines the output value by distinguishing cases where the finger possesses at least a part of the first column, the finger possesses at least a part of the second column, and the finger does not possess the first column and the second column.

4. The method of claim 2, wherein one symbol is assigned to a key positioned at the first column, two symbols are assigned to a key positioned at the second column, and three symbols are assigned to a key positioned at a third column among the plurality of input columns.

5. The method of claim 1, wherein the interface area of the input apparatus comprises a plurality of keys including a plurality of rows and columns.

6. The method of claim 2, wherein the input apparatus determines a first symbol assigned to the particular key as the output value, when deciding that the finger possesses the first column and the second column.

7. The method of claim 2, wherein the input apparatus determines a second symbol assigned to the particular key as the output value, when the finger does not possess the first column, but possess the second column, and at least two symbols are assigned to the particular key.

8. The method of claim 2, wherein the input apparatus determines a third symbol assigned to the particular key as the output value, when the finger does not possess the first column and the second column, and at least three symbols are assigned to the particular key.

9. An input apparatus using detection of possession of a finger, the apparatus comprising:
an input part which includes an interface area, in which a plurality of keys are disposed, and detects an input of a particular key among the plurality of keys;
a sensor which is disposed in a partial area of the interface area and detects a state of possession of a user's finger; and
a control part which determines an output value of the particular key based on a sensing value transmitted from the sensor and a unique identifier of the particular key.

10. The apparatus of claim 9, wherein the interface area comprises a plurality of rows and columns and the plurality of keys are disposed at the plurality of rows and columns, respectively.

11. The apparatus of claim 9, wherein the interface area is formed with three rows and five columns, and the sensor is disposed at a first column and a second column from a left side of the interface area or disposed at a first column and a second column from a right side of the interface area.

12. The apparatus of claim 9, wherein the control part identifies a plurality of symbols set to the particular key based on a unique identifier of the particular key and determines one of the plurality of symbols as the output value based on the sensing value.

13. The apparatus of claim 9, wherein one symbol is set to the particular key when the particular key is positioned at a first column of the interface area, two symbols are set to the particular key when the particular key is positioned at a second column of the interface area, three symbols are set to the particular key when the particular key is positioned at a third column of the interface area, two symbols are set to the particular key when the particularly key is positioned at a fourth column of the interface area, and one symbol is set to the particular key when the particular key is positioned at a fifth column of the interface area.
